(19) United States
(12) Patent Application Publication
(10) Pub. No.: US 2014/0202431 A1
(43) Pub. Date: Jul. 24, 2014

(54) FUEL INJECTION APPARATUS

(71) Applicant: DENSO CORPORATION, Kariya-city (JP)

(72) Inventor: Ryou KATSURA, Anjo-city (JP)

(73) Assignee: DENSO CORPORATION, Kariya-city (JP)

(21) Appl. No.: 14/151,854

(22) Filed: Jan. 10, 2014

(30) Foreign Application Priority Data
Jan. 21, 2013 (JP) 2013-8777

(51) Int. Cl. F02D 1/06

(52) U.S. Cl. CPC F02D 1/06
USPC 123/447

(57) ABSTRACT

A control unit obtains approximation straight lines before and during the fuel injection with respect to a first injection and a second injection among multiple fuel injections based on a pressure variation in the fuel accumulator which is sampled by the pressure sensor. The control unit employs data of which correlation coefficient is higher among a pilot injection and a main injection and obtains a hypothetical injection-start point accurately. Based on the variation amount of the hypothetical injection start delay which is obtained from the hypothetical injection-start point, an energization-start timing and the target-energization period are corrected.

### CROSS-REFERENCE TO RELATED APPLICATION

This application is based on Japanese Patent Application No. 2013-8777 filed on Jan. 21, 2013, the disclosure of which is incorporated herein by reference.

### TECHNICAL FIELD

The present disclosure relates to a fuel injection apparatus which injects a fuel accumulated in a fuel accumulator (common-rail etc.) through a fuel injector.

### BACKGROUND

As shown in FIG. 9A, an injector is energized at an energization-start timing “Ton” and actually injects the fuel at an actual-injection-start timing “Ts”. An actual-injection-start delay “Td” corresponds to a time period between the timing “Ton” and the timing “Ts”. A control device computes a target-injection-start delay “Td0” based on a target-injection-start timing “Ts0”. Then, the control device computes the energization-start timing “Ton” (refer to JP-2003-314338A).

The actual-injection-start delay “Td” may be varied due to an individual difference of the injector, an abrasion wear of moving parts, clogged injection ports, etc. When the actual-injection-start delay “Td” is varied relative to the target-injection-start delay “Td0”, the fuel injection can not be performed at the target-injection-start timing “Ts0”. Moreover, when the actual-injection-start delay “Td” is varied relative to the target-injection-start delay “Td0”, a lift period of a needle is varied so that a target injection quantity “Q”, which the control device computes, can not be obtained.

Before shipment, the individual difference of the fuel injector can be corrected in advance. However, after shipment, the abrasion wear, and the clogging of the injection port may be gradually varied while the fuel injector is used.

It is known that a variation of the fuel pressure is monitored by pressure sensor provided in the fuel accumulator. When the fuel pressure sharply drops, an injection-start point is detected. However, as shown by a solid line in FIG. 9B, in a pressure waveform monitored by the pressure sensor, the fuel pressure waveform is gradually smoothed due to “pressure propagation delay” and “attenuation of a pressure variation”. For this reason, it is difficult to determine the injection-start point based on the pressure drop on the pressure waveform which is monitored by the pressure sensor.

In a multi injection, a pilot injection (small amount injection) and a main injection (large amount injection) are conducted. In the first pilot injection, since the fuel pressure variation is small, it may be difficult to determine the injection-start point based on the pressure drop on the pressure waveform. In the main injection, it may be difficult to determine the injection-start point due to an influence of the pressure pulsation of the pilot injection. For this reason, it is difficult to accurately determine the injection-start point based on the variation of the fuel pressure monitored by the pressure sensor provided in the fuel accumulator.

### SUMMARY

It is an object of the present disclosure to provide a fuel injection apparatus which accurately detects an injection-start point based on a variation of a fuel pressure monitored by a pressure sensor, and corrects an injection-start timing and an injection quantity of a fuel injector with high accuracy even when the multi injection is performed.

The fuel injection apparatus has a control unit. The control unit obtains approximation straight lines before and during the fuel injection with respect to a first injection and a second injection among multiple fuel injections based on a pressure variation in the fuel accumulator which is sampled by the pressure sensor.

Then, the control unit employs data of which correlation coefficient higher among the first injection and the second injection and obtains a hypothetical injection-start point from an intersection point of the approximation straight lines before and during the fuel injection. Based on the hypothetical injection-start point, the injection-start timing and injection quantity of the fuel injector is corrected.

Thus, even in the multi injection, the injection-start point can be detected with high accuracy, so that the injection-start timing and injection quantity of the fuel injector can be corrected with high accuracy.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view of a fuel injection apparatus;

FIG. 2 is a schematic view of a fuel injector;

FIG. 3 is a time chart for explaining an operation of the fuel injection apparatus;

FIG. 4 is a graph for explaining a correlation coefficient of an approximation straight line;

FIGS. 5 to 7 are flowcharts showing an injector control;

FIG. 8 is a graph showing a relationship between an energization period “Tq” and a injection quantity Q; and

FIGS. 9A and 9B are time charts for explaining a conventional injector control.

### DETAILED DESCRIPTION

Referring to drawings, embodiments of the present disclosure will be described hereinafter.

The present disclosure is not limited to the following embodiments.

### First Embodiment

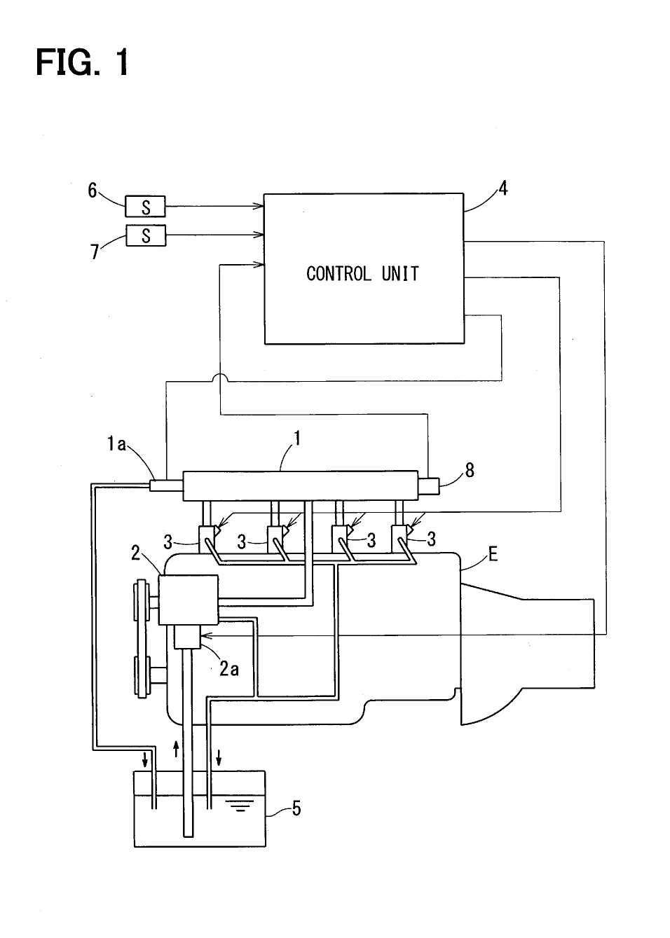

Referring to FIGS. 1 to 8, a fuel injection apparatus of a first embodiment will be described hereinafter. The fuel injection apparatus is a system which performs fuel injection to a diesel engine, for example. The diesel engine is referred to as the engine E, hereinafter. As shown in FIG. 1, the fuel injection apparatus is provided with a common-rail 1, a supply pump 2, fuel injectors 3 and a control unit 4. The control unit 4 is comprised of an electronic control unit (ECU), and electronic drive unit (EDU).

The common-rail 1 is an accumulator accumulating high-pressure fuel supplied from the supply pump 2. The accumulated high-pressure fuel is supplied to the fuel injectors 3.

The supply pump 2 is provided with a high-pressure pump which pressurizes the fuel suctioned from a fuel tank 5 by a feed pump (low-pressure pump). The pressurized high-pressure fuel is introduced into the common-rail 1. The supply pump 2 has a metering valve 2a which adjusts a feed quantity of the high-pressure pump. The control unit 4 controls the metering valve 2a and a pressure-reducing valve 1a so that the fuel pressure in the common-rail 1 is adjusted to a target pressure.

Each fuel injector 3 is mounted to each cylinder of the engine E. When the control unit 4 energizes the fuel injector 3, the fuel injector 3 injects the high-pressure fuel accumulated in the common-rail 1 into the cylinder. When the control unit 4 deenergizes the fuel injector 3, the fuel injection is terminated.

In the present embodiment, two-way fuel injector 3 is employed. The type of the fuel injector 3 is not limited to two-way type. The fuel injector 3 is an electromagnetic fuel injection valve which has a nozzle i3 and an electromagnetic valve i4. When the high-pressure fuel is introduced into a backpressure chamber i1 (control chamber), the needle i2 closes the nozzle i3. The electromagnetic valve i4 is for discharging the high-pressure fuel in the backpressure chamber i1.

Specifically, the fuel injector 3 injects the high-pressure fuel supplied from the common-rail 1 into the cylinder of the engine E. The high-pressure fuel in the common-rail 1 is introduced into the backpressure chamber i1 through an inflow passage i5. The inflow passage i5 has an in-orifice therein. The backpressure chamber i1 also communicates with a discharge passage i6. The discharge passage i6 has an out-orifice therein. The electromagnetic valve i4 opens and closes the discharge passage i6 so that the fuel pressure in the backpressure chamber i1 is varied. When the fuel pressure in the backpressure chamber i1 falls to a specified value, the needle i2 slides up to open the injection port i15 of the nozzle i3.

In a housing of the fuel injector 3, a cylinder i8, a high-pressure fuel passage i9, and a low-pressure fuel discharge passage i10 are formed. The cylinder i8 supports a command piston i7 in its axial direction. The high-pressure fuel passage i9 introduces the high-pressure fuel supplied from the common-rail 1 toward the nozzle i3 and the inflow passage i5. The low-pressure fuel discharge passage i10 is for discharging the leak fuel toward a low-pressure portion.

The command piston i7 is inserted in the cylinder i8 and is connected to the needle i2 through a pressure pin. The pressure pin is arranged between the command piston i7 and the needle i2. A spring i11 is disposed around the pressure pin. The spring i11 biases the needle i2 downward (valve close direction).

The backpressure chamber i1 is defined above the cylinder i8. A volume of the backpressure chamber i1 is varied according to an axial movement of the command piston i7. The inflow passage i5 is a fuel throttle which reduces the pressure of the fuel supplied through the high-pressure fuel passage i9. The high-pressure fuel passage i9 and the backpressure chamber i1 communicate with each other through the inflow passage i5. The discharge passage i6 is formed above the backpressure chamber i1. The discharge passage i6 is a fuel throttle which reduces the pressure of the fuel discharged to the low-pressure fuel discharge passage i10. The backpressure chamber i1 and the low-pressure fuel discharge passage i10 communicate with each other through the discharge passage i6.

The electromagnetic valve i4 has a solenoid i12, a valve i13 and a return spring i14. The solenoid i12 generates an electromagnetic force when energized. The valve 13 is attracted toward the solenoid i12. That is, the valve 13 is attracted in a valve-open direction. The return spring i14 biases the valve i13 in a valve-close direction. For example, the valve i13 is a ball valve which opens and closes the discharge passage i6. When the solenoid i12 is OFF, the valve i13 is biased downward by the return spring i14 to close the discharge passage i6.

Meanwhile, when the solenoid i12 is ON, the valve i13 is attracted toward the solenoid i12 against the biasing force of the return spring i14, so that the valve i13 opens the discharge passage i6.

The housing of the injector 3 has a hole into which the needle i2 slidably inserted, a nozzle chamber annularly formed around the needle i2, a conical valve seat on which the needle i2 sits, and an injection port i15 through which the high-pressure fuel is injected.

The needle i2 is comprised of a sliding shaft, a small diameter shaft and a conical valve which opens and closes the injection port i15. The sliding shaft seals a clearance between the nozzle chamber and a space around the return spring i11.

The conical valve of the needle 12 is comprised of a conical base portion and a conical tip end portion. A valve-sit seat is formed between the conical base portion and the conical tip end portion. A conical angle of the conical base portion is smaller than that of the conical tip end portion. A conical angle of the conical tip end portion is larger than that of the valve seat. When the valve-sit seat is contact with the valve seat, the injection ports i15 are closed.

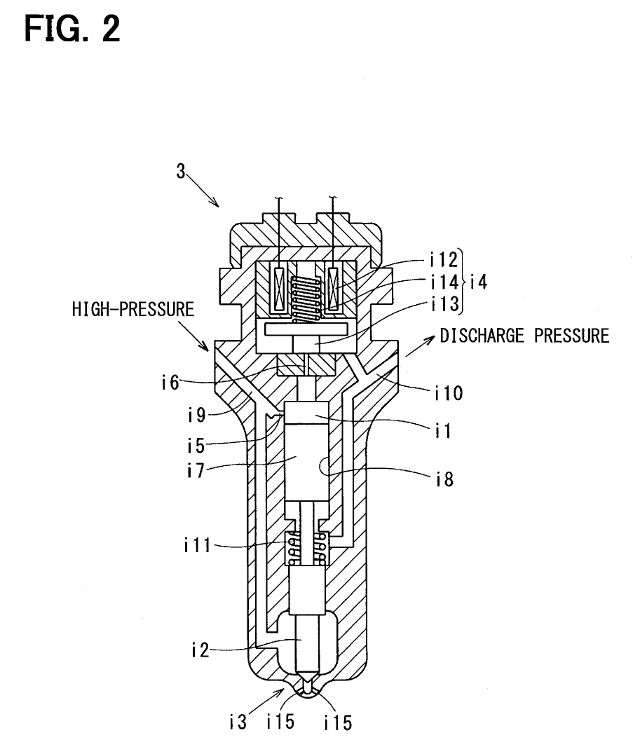

Referring to FIG. 2, an operation of the fuel injector 3 will be described.

When the fuel injector 3 is energized at an energization-start timing “Ton”, the electromagnetic valve i4 attracts the valve i13. When the valve i13 is lifted up, the discharge passage i6 is opened, so that the fuel pressure in the backpressure chamber i1 is decreased. When the fuel pressure in the backpressure chamber i1 is lowered than the specified value, the needle i2 starts lifting up. When the needle i2 is apart from the valve seat, the nozzle chamber communicates with the injection ports i15 and the high pressure fuel in the nozzle chamber is injected through the injection ports i15. The actual-injection-start delay “Td” is a time period from the energization-start timing “Ton” until the time when the fuel injector 3 actually injects the fuel.

When the fuel injector is deenergized at an energization-end timing “Toff”, the electromagnetic valve i4 stops generating the electromagnetic attracting force. The valve i13 starts lifting down. When the valve i13 closes the discharge passage i6, the fuel pressure in the backpressure chamber i1 starts increasing. When the fuel pressure in the backpressure chamber i1 is increased up to the specified value, the needle i2 starts sliding down. When the needle i2 sits on the valve seat, the nozzle chamber and the injection ports i15 are fluidly disconnected so that the fuel injection is terminated. The actual-injection-end delay is a time period from an energization-end-timing “Toff” until the time when the fuel injector 3 actually terminates the fuel injection.

The control unit 4 includes a well-known microcomputer. The control unit 4 receives various sensor signals from the various sensors. Based on the sensor signals, the control unit 4 executes various computations to perform a pressure control of the common-rail 1 and a driving control of the fuel injector 3. In this embodiment, an accelerator sensor 6 detecting an accelerator position, an engine speed sensor 7, a coolant temperature sensor, and a pressure sensor 8 detecting the fuel pressure in the common-rail 1 are connected to the control unit 4.

According to the present embodiment, the fuel injection apparatus performs the multi-injection, so that an engine vibration and an engine noise are reduced, exhaust gas is purified, the engine output is enhanced and the fuel consumption is reduced.

Specifically, the multi-injection is comprised of a pilot injection and a main injection. The fuel injection quantity in the pilot injection is smaller than that in the main injection. The pilot injection can be performed once or multiple times before the main injection.

The control unit 4 computes the target-injection-start timing “Ts0” and the target injection quantity “Q” with respect to each fuel injection according to control programs stored in the ROM and the control parameters transmitted from the sensors. Then, the control unit 4 controls the fuel injector 3 in such a manner that the fuel injection is started at the target-injection-start timing “Ts0” and the fuel injection quantity agrees with the target injection quantity “Q”.

The control unit 4 obtains the energization-start timing “Ton” by subtracting the target-injection-start delay “Td0” from the target-injection-start timing “Ts0”.

That is, “Ton”=“Ts0”−“Td0”

Further, the control unit 4 obtains a target-energization period “Tq0” based on the target injection quantity “Q” and the fuel pressure in the common-rail 1. The target-energization period “Tq0” is a period from the energization-start timing “Ton” until the energization-end timing “Toff”

The actual-injection-start delay “Td” is varied due to an individual difference of the fuel injector 3, an abrasion wear of moving parts, clogged injection ports, etc. The individual difference of the fuel injector 3 is corrected before shipment. However, after shipment, the abrasion wear and the clogging of the injection port may be gradually varied while the fuel injector 3 is used.

That is, the actual-injection-start timing “Ts” may deviate from the target-injection-start timing “Ts0” due to the abrasion wear, the clogging of the injection port, etc.

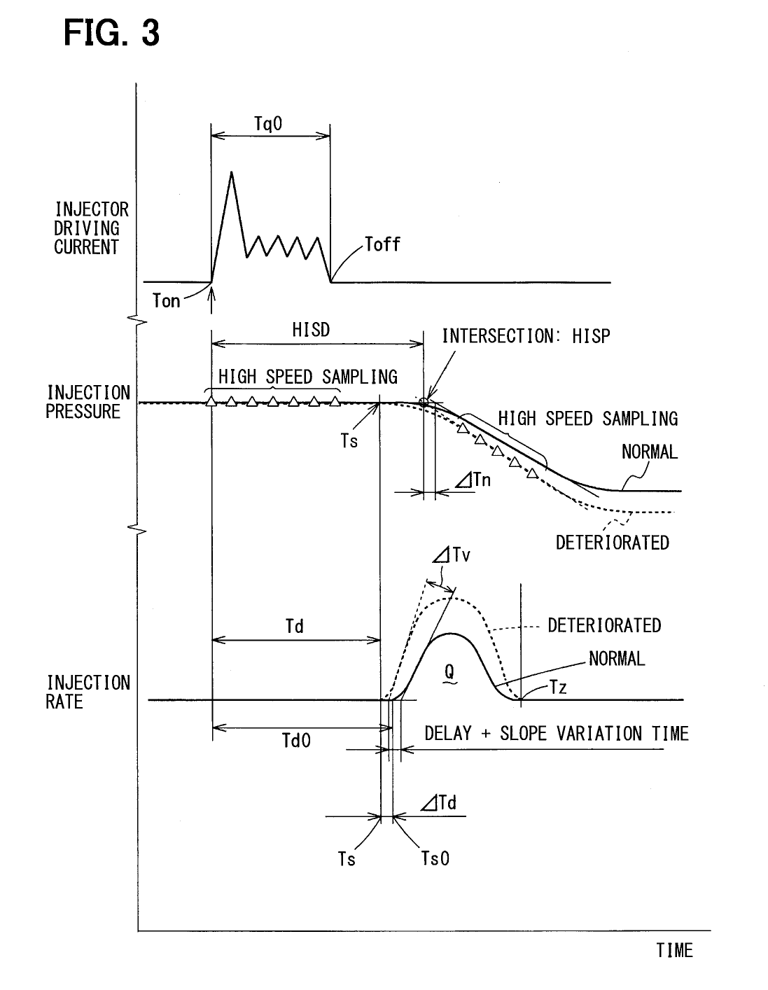

Referring to FIG. 3, a specific example will be described.

When the contacting surfaces of the needle i2 and the valve seat are worn, the needle i2 removes from the valve seat at earlier timing. Then, the actual-injection-start timing “Ts” is advanced and the actual-injection-start delay “Td” becomes shorter relative to the target-injection-start delay “Td0”.

Similarly, when the contacting surfaces of the needle i2 and the valve seat are worn, the seating timing of the needle i2 is delayed. Then, an actual-injection-end timing “Tz” is delayed and an actual-injection-end delay becomes longer relative to a target-injection-end delay.

As above, when the actual-injection-start timing “Ts” and/or the actual-injection-end timing “Tz” deviates from the target timing, the fuel injection can not be performed at the target-injection-start timing “Ts0” and the fuel of the target injection quantity “Q” can not be injected through the fuel injector 3.

In order to avoid the above problems, according to the present embodiment, the control unit 4 performs a high speed sampling of the accumulated fuel pressure by using of the pressure sensor 8. The control unit 4 obtains a hypothetical injection-start point based on the variation of the accumulated fuel pressure. Based on the hypothetical injection-start point, the control unit 4 corrects the injection-start timing and the injection quantity of the fuel injector 4. The hypothetical injection-start point is denoted by “HISP” in FIG. 3.

Specifically, based on a variation amount “ΔTn” of the hypothetical injection start delay “HISD” relative to the target hypothetical injection delay, the control unit 4 corrects the energization-start timing “Ton” and the actual-injection-start timing “Ts”. That is, the target-injection-start delay “Td0” is corrected.

Further, the control unit 4 corrects the energization-end timing “Toff” and the actual-injection-end timing “Tz”. More specifically, the target-energization period “Tq0” of the fuel injector 3 is corrected.

The variation amount “ΔTn” of the hypothetical injection start delay is a sum value of a variation amount “ΔTd” of the actual-injection-start delay and a time difference “ΔTv” corresponding to a variation amount of an actual initial needle displacement speed from a target initial needle displacement speed. The variation amount “ΔTd” of the actual-injection-start delay is a difference value between the target-injection-start delay “Tdo” and the actual-injection-start delay “Td”.

Moreover, in order to improve a calculation accuracy of the hypothetical injection-start point, when the control unit 4 performs the multi-injection, the control unit 4 obtains approximation straight lines before and during fuel injection in a first pilot injection based on the pressure variation of accumulated fuel sampled by the pressure sensor 8 (refer to step A1 to step A13 which will be described later).

Then, the control unit 4 obtains an approximation straight line before and during fuel injection in the main injection (refer to step B1 to step B13 which will be described later). The main injection corresponds to the second injection.

Then, the control unit 4 employs the data which have higher correlation coefficient relative to the approximation straight line among the first pilot injection and the main injection. The control unit 4 obtains the hypothetical injection-start point based on an intersection of the approximation straight line before fuel injection and the approximation straight line during fuel injection (refer to step C1 to step C7 which will be described later). That is, based on the correlation coefficient relative to the approximation straight line, the control unit 4 selects the hypothetical injection-start point which is more accurate among the first pilot injection and the main injection.

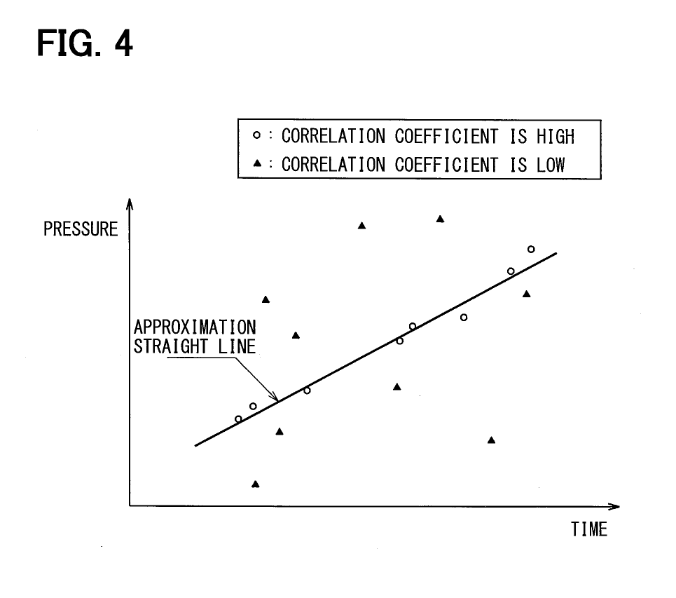

Referring to FIG. 4, the correlation coefficient relative to the approximation straight line will be described, hereinafter.

When the correlation coefficient is high, the plot data exists near the approximation straight line. The plot data are denoted by “∘” in FIG. 4. When the correlation coefficient is low, the plot data exists apart from the approximation straight line. The plot data are denoted by “▴” in FIG. 4. In the present embodiment, the control unit 4 employs the data of which correlation coefficient relative to the approximation straight line is higher.

As described above, the control unit 4 corrects the injection-start timing and the injection quantity of the fuel injector 3 based on the hypothetical injection-start point. Specifically, the energization-start timing “Ton” and the target-energization period “Tqo” are corrected (refer to steps C8 and C9).

Referring to FIG. 3, a specific control will be described.

When obtaining the hypothetical injection-start point, the control unit 4 obtains the approximation straight line before fuel injection and the approximation straight line during fuel injection with respect to the first pilot injection and the main injection, respectively. First, the control before fuel injection in the first pilot injection will be explained.

The pressure variation of immediately before fuel injection start is sampled by the pressure sensor 8. The least square approximation is executed based on the specified number of pressure samples. In FIG. 3, the least square approximation is executed based on seven pressure samples. In the two-way fuel injector 3 having a static leak, the fuel pressure is slightly decreased even immediately before the fuel injection. In a case that absolute values of a pressure variation before and after sampling are out of the specified range, the sampled data is deleted. The approximation is executed based on other sampled data.

At the same time, the control unit 4 computes a correlation coefficient of the approximation. When the computed correlation coefficient is greater than or equal to a specified value, and a slope of the approximation straight line is within a specified range, the approximation straight line is employed as the approximation straight line immediately before fuel injection. Then, the last employed approximation straight line is defined as the final approximation straight line.

Next, the control of during the injection in the first pilot injection will be explained. The pressure variation immediately after fuel injection is sampled by the pressure sensor 8. The least square approximation is executed based on a specified number of the pressure samples. In FIG. 3, the least square approximation is executed based on five pressure samples. In a case that absolute values of a pressure variation before and after sampling are out of the specified range, the sampled data is deleted. The approximation is executed based on other sampled data.

At the same time, the control unit 4 computes a correlation coefficient of the approximation. When the computed correlation coefficient is greater than or equal to a specified value, and a value obtained by subtracting a slope of the approximation straight line immediately before injection from the slope of the approximation straight line is within a specified range, the approximation straight line is employed as the approximation straight line immediately after fuel injection. The reason for subtracting the slope of the approximation straight line immediately before fuel injection is for delete a slope of decreasing fuel pressure due to the static leak. Thus, the approximation straight line can be obtained based on the injection pressure without respect to the static leak and the individual difference of the fuel injector 3. Then, the first employed approximation straight line immediately after fuel injection start is defined as the final approximation straight line.

The hypothetical injection-start point of the first pilot injection is computed by using of the intersection of the approximation straight line employed last immediately before the fuel injection start and the approximation straight line employed first immediately after the fuel injection start. Thus, the detection accuracy of the hypothetical injection-start point of the first pilot injection can be improved.

Since the first pilot injection has less influence of previous injection pulsation, it is advantageous for detecting the hypothetical injection-start point. However, since the injection quantity is relatively small, it is relatively difficult to approximate to a straight line. Thus, the hypothetical injection-start point of the main injection is also detected.

The approximation straight lines before and after the fuel injection start are computed. The hypothetical injection-start point of the main injection is computed by using of the intersection of the approximation straight line employed last immediately before the fuel injection start and the approximation straight line employed first immediately after the fuel injection start. Thus, the detection accuracy of the hypothetical injection-start point can be improved.

In the main injection, the injection quantity is relatively large and the pressure variation is also large. However, a pressure wave form is disturbed by the pressure pulsation of the previous pilot injection. Thus, it is difficult to detect the hypothetical injection-start point. So, the correlation coefficient of the approximation straight line employed immediately after the fuel injection start of the first pilot injection is compared with the correlation coefficient of the approximation straight line employed immediately before the fuel injection start of the main injection. The control unit 4 obtains the hypothetical injection-start point based on the data of which correlation coefficient is higher.

A time difference between the obtained hypothetical injection-start point and the energization-start timing “Ton” is referred to as a hypothetical injection start delay “HISD”.

In a case that the data of the main injection is employed, a variation of the pressure pulsation is corrected. Specifically, the pressure pulsation occurs at a specified interval. The control unit 4 corrects the hypothetical injection start delay at the specified interval by using of mathematical formula or a map for correcting the injection quantity.

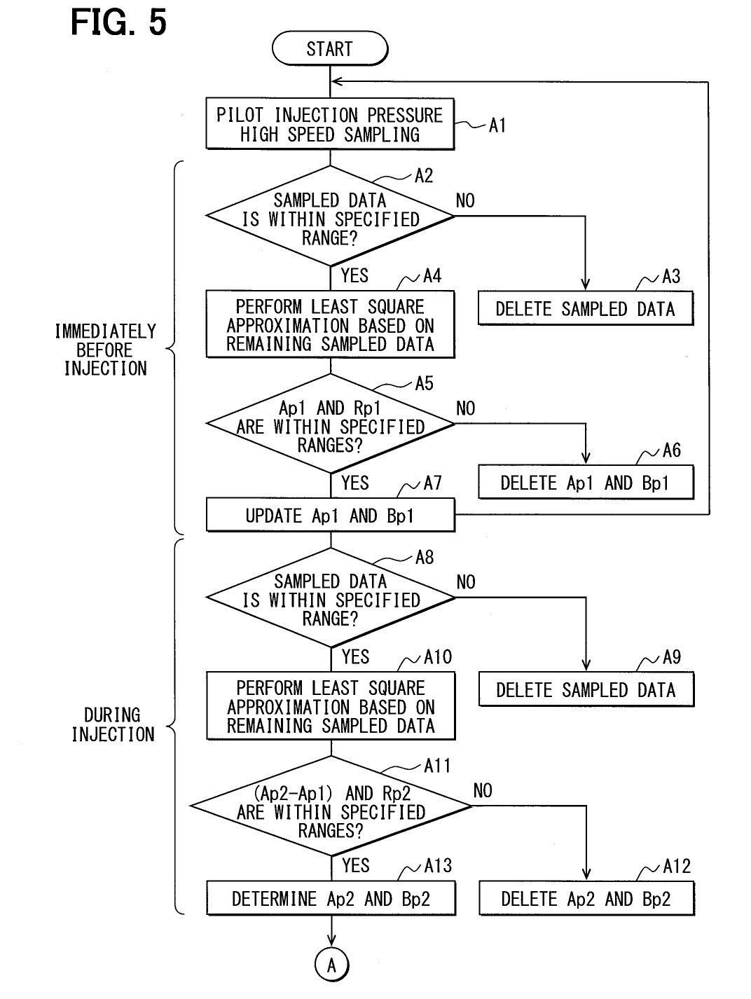

Referring to a flowchart shown in FIGS. 5 to 7, the above “correction program” will be explained.

In step A1, the variation of the fuel pressure in the first pilot injection is monitored by a high speed sampling. In the following steps A2 to A7, the straight-line approximation immediately before the fuel injection of the first pilot injection is performed. In steps A8 to A13, the straight-line approximation immediately after the fuel injection of the first pilot injection is performed.

In step A2, it is determined whether the sampled data (pressure value) is within a specified range relative to the before-and-after data (before-and-after pressure values).

When the answer in NO in step A2, the procedure proceeds to step A3 in which the sampled data is deleted as noise data. When the answer is YES in step A2, the procedure proceeds to step A4 in which the least square approximation is performed based on the remaining sampled data.

In step A5, it is determined whether a slope Ap1 of the approximation straight line obtained in step A4 is within a specified range and the correlation-coefficient Rp1 is also within a specified range. When the answer is NO in step A5, the procedure proceeds to step A6 in which the slope Ap1 and an intercept BP1 are deleted as inappropriate data. When the answer is YES in step A5, the procedure proceeds to step A7 in which the slope Ap1 and the intercept BP1 are updated.

In step A8, it is determined whether the sampled data (pressure value) is within a specified range relative to the before-and-after data (before-and-after pressure values).

When the answer in NO in step A8, the procedure proceeds to step A9 in which the sampled data is deleted as noise data. When the answer is YES in step A8, the procedure proceeds to step A10 in which the least square approximation is performed based on the remaining sampled data.

In step A11, it is determined whether a slope “AP2-AP1” of the straight line is within a specified range and the correlation-coefficient Rp2 is also within a specified range. When the answer is NO in step A11, the procedure proceeds to step A12 in which the slope Ap2 and the intercept Bp2 are deleted as inappropriate data. The slope Ap2 is a slope of a decreasing straight line due to the static leak.

When the answer is YES in step A11, the procedure proceeds to step A13 in which the slope Ap2 and the intercept Bp2 are determined.

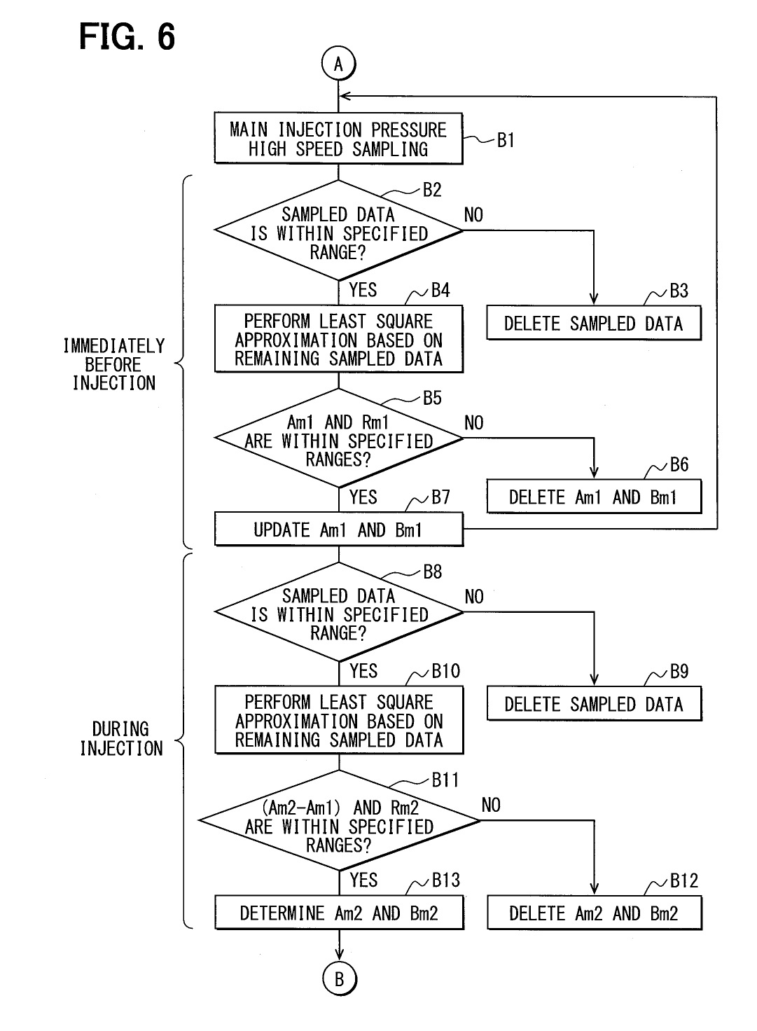

As shown in FIG. 6, in step B1, the variation of the fuel pressure in the main injection is monitored by a high speed sampling.

In the following steps B2 to B7, the straight-line approximation immediately before the fuel injection of the main injection is performed. In steps B8 to B13, the straight-line approximation immediately after the fuel injection of the main injection is performed.

In step B2, it is determined whether the sampled data (pressure value) is within a specified range relative to the before-and-after data (before-and-after pressure values).

When the answer is NO in step B2, the procedure proceeds to step B3 in which the sampled data is deleted as noise data. When the answer is YES in step B2, the procedure proceeds to step B4 in which the least square approximation is performed based on the remaining sampled data.

In step B5, it is determined whether a slope Am1 of the approximation straight line obtained in step B4 is within a specified range and the correlation-coefficient Rm1 is also within a specified range. When the answer is NO in step B5, the procedure proceeds to step B6 in which the slope Am1 and the intercept Bm1 are deleted as inappropriate data. When the answer is YES in step B5, the procedure proceeds to step B7 in which the slope Am1 and the intercept Rm1 are updated.

In step B8, it is determined whether the sampled data (pressure value) is within a specified range relative to the before-and-after data (before-and-after pressure values). When the answer in NO in step B8, the procedure proceeds to step B9 in which the sampled data is deleted as noise data. When the answer is YES in step B8, the procedure proceeds to step B10 in which the least square approximation is performed based on the remaining sampled data.

In step B11, it is determined whether a slope “Am2-Am1” of straight line is within a specified range and the correlation-coefficient Rm2 is also within a specified range. The slope Am1 is a slope of a decreasing straight line due to the static leak.

When the answer is NO in step B11, the procedure proceeds to step B12 in which the slope Am2 and the intercept Rm2 are deleted as inappropriate data. When the answer is YES in step B11, the procedure proceeds to step B13 in which the slope Am2 and the intercept Rm2 are determined.

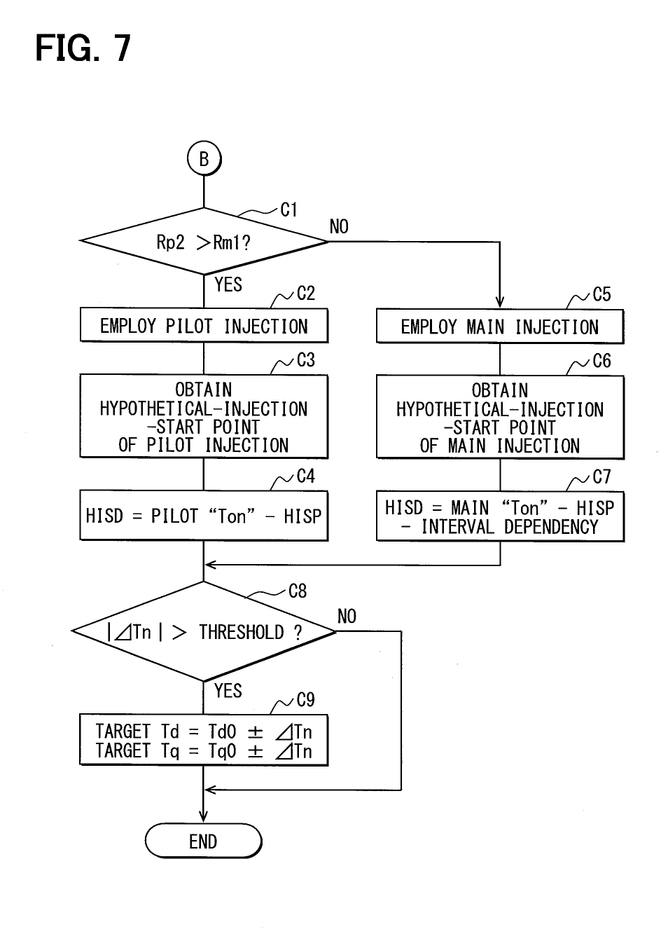

As shown in FIG. 7, in step C1, it is determined whether the correlation-coefficient Rp2 obtained in step A13 is greater than the correlation-coefficient Rm1 obtained in step B7. When the answer is YES in step C1, the procedure proceeds to step C2 in which the approximation straight line of the pilot injection is employed for computation. In step C3, the hypothetical injection-start point is obtained based on the intersection point of the approximation straight line obtained in step A7 and the approximation straight line obtained in step A13. In step C4, the hypothetical injection-start point is subtracted from the energization-start timing “Ton” to obtain the hypothetical injection start delay of the first pilot injection.

When the answer is NO in step C1, the procedure proceeds to step C5 in which the approximation straight line of the main injection is employed for computation. In step C6, the hypothetical injection-start point is obtained based on the intersection point of the approximation straight line obtained in step B7 and the approximation straight line obtained in step B13. In step C7, the hypothetical injection-start point is subtracted from the energization-start timing “Ton” to obtain the hypothetical injection start delay of the main injection. At this time, an influence of pressure pulsation applied to the hypothetical injection start delay is corrected based on an interval dependency. That is, in view of the influence of the pressure pulsation, the hypothetical injection start delay of the main injection is computed.

In step C8, a variation amount “ΔTn” of the hypothetical injection start delay relative to the target hypothetical injection start delay is obtained. Then, it is determined whether the variation amount “ΔTn” is out of an appropriate range. When the answer is YES in step C8, the variation amount “ΔTn” is stored as a learning value.

When the answer is NO in step C8, the control routine is terminated. When the answer is YES in step C8, the procedure proceeds to step C9.

In step C9, the target hypothetical injection start delay is corrected based on the variation amount “ΔTn” obtained in step C7 so as to correct the energization-start timing “Ton” and the target-energization period “Tqo”. After executing step C9, the control routine is terminated.

### First Advantage of Embodiment

As mentioned above, in the fuel injection apparatus, the pressure variation in accumulated fuel is monitored by the high speed sampling. Based on the intersection point of the approximation straight lines of before and after fuel injection, the hypothetical injection-start point is obtained. The fuel injection timing and the fuel injection quantity of the fuel injector 3 are corrected based on the hypothetical injection-start point. Specifically, based on the variation amount “ΔTn”, the energization-start timing “Ton” and the target-energization period “Tq0” are corrected. Thus, even if an abrasion wear or a clogging occurs in the fuel injector 3, the fuel injection can be accurately performed at the target-injection-start timing “Ts0” and the target injection quantity “Q” can be accurately injected.

Specifically, the fuel injection timing and the fuel injection quantity can be corrected based on only the fuel pressure drop without respect to the individual difference of the pressure sensor 8, the fuel property, a variation of the volume modulus of the fuel, etc.

### Second Advantage of Embodiment

The fuel injection apparatus obtains the hypothetical injection-start point based on the data of which correlation coefficient is higher relative to the approximation straight line among the first pilot injection and the main injection. Thus, the accuracy of the hypothetical injection-start point is improved so that the injection-start timing and injection quantity of the fuel injector 3 can be corrected with high accuracy.

### Third Advantage of Embodiment

As above, the injection-start timing and injection quantity of the fuel injector 3 is corrected based on the hypothetical injection-start point. Thus, the initial moving speed of the needle i2 can be corrected.

### Fourth Advantage of Embodiment

The fuel injection apparatus can determine whether the fuel injector 3 is deteriorated based on the absolute value of the variation amount “ΔTn”. Thus, the quality of the fuel injector 3 can be checked before and after shipment.

### Fifth Advantage of Embodiment

When an absolute value of the data before the approximation is out of the specified range, the fuel injection apparatus does not employ the data. Thus, the computation accuracy of the hypothetical injection-start point can be improved so that the correction accuracy of the fuel injector can be enhanced.

### Sixth Advantage of Embodiment

When the correlation-coefficient relative to the approximation straight line is out of the specified range, the fuel injection apparatus does not employ the data. Thus, the computation accuracy of the hypothetical injection-start point can be improved so that the correction accuracy of the fuel injector can be enhanced.

### Seventh Advantage of Embodiment

The fuel injection apparatus obtains the approximation straight line immediately before the fuel injection based on the sampled data immediately before the fuel injection. Thus, the computation accuracy of the hypothetical injection-start point can be improved so that the correction accuracy of the fuel injector can be enhanced.

### Eighth Advantage of Embodiment

The fuel injection apparatus obtains the approximation straight line during the fuel injection based on the sampled data immediately after the fuel injection. Thus, the computation accuracy of the hypothetical injection-start point can be improved so that the correction accuracy of the fuel injector can be enhanced.

### Ninth Advantage of Embodiment

In view of the static leak quantity which returns to the fuel tank 5 from the fuel injector 3, the fuel injection apparatus obtains the approximation straight line based on the data except the pressure variation due to the static leak. Thus, the computation accuracy of the hypothetical injection-start point can be improved so that the correction accuracy of the fuel injector can be enhanced.

### Tenth Advantage of Embodiment

In view of the pressure pulsation transmitted to the fuel accumulator, the fuel injection apparatus obtains the approximation straight line of the main injection based on the pressure variation of the accumulated fuel. Thus, the computation accuracy of the hypothetical injection-start point can be improved so that the correction accuracy of the fuel injector can be enhanced.

### First Modification of Embodiment

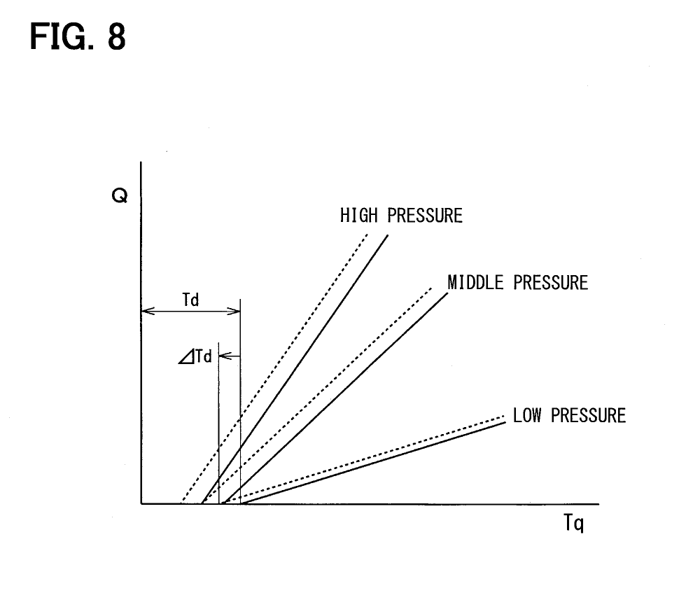

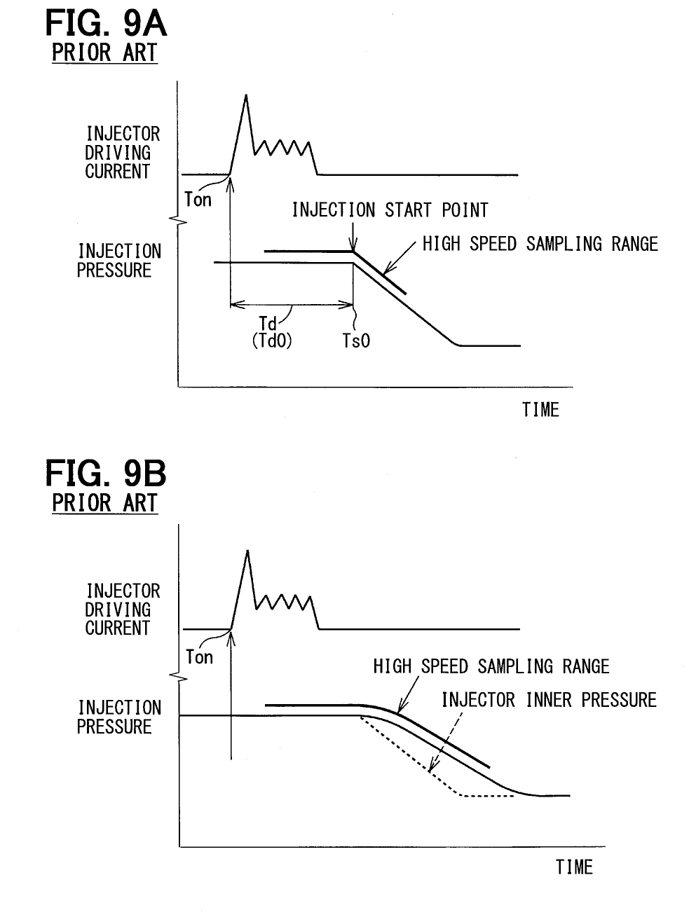

As shown in FIG. 8, the hypothetical injection start delay is varied according to the accumulated fuel pressure (fuel injection pressure). So, the variation amount “ΔTn” of the hypothetical injection start delay is obtained according to the variation of the fuel injection pressure. Based on the variation amount “ΔTn”, the energization-start timing “Ton” and the target-energization period “Tq0” may be corrected.

### Second Modification of Embodiment

As shown in FIG. 8, the hypothetical injection start delay is varied according to the accumulated fuel pressure (fuel injection pressure). So, based on the relationship between the learned variation amount “ΔTd” of the actual-injection-start delay and the fuel pressure, the variation amount “ΔTd” is corrected. Based on the corrected variation amount “ΔTd”, the target-injection-start delay “Td0” and the target-energization period “Tq0” may be corrected.

### Third Modification of Fourth Embodiment

In the above embodiment, the fuel injection quantity is increased. That is, the hypothetical injection start delay becomes shorter. Meanwhile, it can be assumed that the hypothetical injection start delay becomes longer so that the fuel injection quantity is decreased. In a case that the injection quantity is decreased, it is likely than no fuel is injected in the pilot injection. In such a case, the target-energization period “Tq0” is gradually made longer. Then, when a fuel injection is confirmed, the target-injection-start delay “Td0” and the target-energization period “Tq0” may be corrected based on the variation amount “ΔTn” of the hypothetical injection start delay.

Above disclosure can be applied to a fuel injection apparatus of a gasoline engine.

The fuel injector 3 may be a three-way injector, a direct-type fuel injector, a piezo actuator, etc.

The control unit 4 controls each of the multiple fuel injectors 3 independently.

What is claimed is:

1. A fuel injection apparatus comprising:
a fuel accumulator accumulating a fuel therein;
a fuel injector injecting the fuel accumulated in the fuel accumulator;
a pressure sensor sampling a fuel pressure in the fuel accumulator; and
a control unit performing an injection control of the fuel injector based on a driving condition which includes the fuel pressure detected by the pressure sensor, wherein
the fuel injector can perform multiple fuel injections into a cylinder during one combustion cycle,
the control unit obtains approximation straight lines before and during the fuel injection with respect to a first injection and a second injection among multiple fuel injections based on a pressure variation in the fuel accumulator which is sampled by the pressure sensor,
the control unit employs data of which correlation coefficient higher among the first injection and the second injection and obtains a hypothetical injection-start point based on an intersection point of the approximation straight lines before and during the fuel injection, and
the control unit corrects an injection-start timing and an injection quantity of the fuel injector based on the hypothetical injection-start point.

2. A fuel injection apparatus according to claim 1, wherein
the first injection is a first pilot injection in the multi fuel injections, and
the second injection is a main injection in the multi fuel injections.

3. A fuel injection apparatus according to claim 1, wherein
the control unit corrects an initial displacement speed of a needle based on the hypothetical injection-start point.

4. A fuel injection apparatus according to claim 1, wherein:
the control unit determines whether the fuel injector is deteriorated based on the hypothetical injection-start point.

5. A fuel injection apparatus according to claim 1, wherein:
in a case that an absolute value of a pressure data before an approximation is out of the specified range, the control unit employs another pressure data.

6. A fuel injection apparatus according to claims 1, wherein:
in a case that a correlation-coefficient of a pressure data relative to an approximation straight line is out of the specified range, the control unit employs another pressure data.

7. A fuel injection apparatus according to claim 1, wherein:
the control unit obtains the approximation straight line before the fuel injection based on a sampled data which is sampled immediately before the fuel injection by the pressure sensor.

8. A fuel injection apparatus according to claim 1, wherein:
the control unit obtains the approximation straight line during the fuel injection based on a sampled data which is sampled immediately after the fuel injection by the pressure sensor.

9. A fuel injection apparatus according to claim 1, wherein:
the control unit controls the fuel injector in view of a static leak in a case that the static leak exists in the fuel injector.

10. A fuel injection apparatus according to claim 1, wherein:
the control unit obtains the approximation straight line of the second injection based on the pressure variation of the accumulated fuel sampled by the pressure sensor, in view of a pressure pulsation transmitted to the fuel accumulator.

11. A fuel injection apparatus according to claim 1, wherein:
the control unit corrects an energization-start timing and a target-energization period based on the hypothetical injection-start point.
